(19) United States
(12) Patent Application Publication
(10) Pub. No.: US 2026/0067005 A1
(43) Pub. Date: Mar. 5, 2026

(54) RF INTERFERENCE LOCALIZATION AND VISUALIZATION

(71) Applicant: VIAVI SOLUTIONS INC., Chandler, AZ (US)

(72) Inventor: Eduardo INZUNZA, Los Gatos, CA (US)

(73) Assignee: VIAVI SOLUTIONS INC., Chandler, AZ (US)

(21) Appl. No.: 19/097,117

(22) Filed: Apr. 1, 2025

Related U.S. Application Data
(60) Provisional application No. 63/689,381, filed on Aug. 30, 2024.

(51) Int. Cl. H04B 17/15

(52) U.S. Cl. CPC H04B 17/15

(57) ABSTRACT

According to examples, an apparatus for localizing and visualizing radio RF interference may include an RF enclosure having an opening and an RF antenna housed within the RF enclosure. The RF enclosure may cause RF signals entering the opening to be directed to the RF antenna to increase the directivity of the RF antenna. The apparatus may also include a camera positioned in line with the RF antenna to capture images of objects in a field of view of the camera. A test device may display a heat map of the detected RF signals over a display of the captured images. A user may determine whether an object in the displayed image is a source of RF interference based on the displayed heat map.

### PRIORITY

This application claims priority to commonly assigned and co-pending U.S. Provisional Patent Application No. 63/689,381, filed Aug. 30, 2024, titled “RF INTERFERENCE LOCALIZATION AND VISUALIZATION,” the disclosure of which is hereby incorporated by reference in its entirety.

### BACKGROUND

A cell site, also known as a cell tower or cellular base station, includes a radio, an antenna and electronic communications equipment that are often mounted on towers or rooftops to support cellular communication. The cell site communicates over the air with user equipment (UE) or customer premise equipment (CPE), and has a network interface via wireless or wireline networks, which may include fiber optic cables and coaxial cables. Cellular mobile devices communicating with cell sites generally constitute a local subnetwork, while the connection between the cell site and the rest of the world may be referred to as a backhaul link or simply backhaul.

### BRIEF DESCRIPTION OF THE DRAWINGS

Features of the present disclosure are illustrated by way of examples shown in the following figures. In the following figures, like numerals indicate like elements, in which:

FIG. 1A illustrates a side perspective view of an apparatus for localizing and visualizing RF interference, according to an example of the present disclosure;

FIG. 1B illustrates a side perspective view of an RF enclosure with an RF reflective material to cause constructive interference of RF signals of the apparatus depicted in FIG. 1A, according to an example of the present disclosure;

FIG. 1C illustrates a side perspective view of an RF enclosure with an RF absorbent material to cause attenuation of non-directional RF signals of the apparatus depicted in FIG. 1A, according to an example of the present disclosure;

FIGS. 1D and 1E, respectively, show side perspective views of apparatuses for localizing and visualizing RF interference, according to examples of the present disclosure;

FIG. 1F shows a side perspective view of an RF enclosure with a combination of an RF absorbent material to cause attenuation of non-directional RF signals and an RF reflective material to cause constructive interference of RF signals of an apparatus for localizing and visualizing RF interference, according to an example of the present disclosure;

FIG. 1G shows a side perspective view of an apparatus having the RF enclosure shown in FIG. 1F, according to an example of the present disclosure;

FIGS. 2A and 2B, respectively, show side perspective views of the apparatus depicted in FIG. 1A, in which the RF enclosure of the apparatus has a variable length, according to an example of the present disclosure;

FIG. 3 shows a diagram of a system for localizing and visualizing RF interference, e.g., PIM interference, which includes the apparatus shown in FIG. 1A, according to an example of the present disclosure;

FIG. 4 shows a block diagram of the system depicted in FIG. 3, according to an example of the present disclosure; and

FIG. 5 illustrates a flow diagram of a method for localizing and visualizing RF interference, e.g., PIM interference, according to an example of the present disclosure.

### DETAILED DESCRIPTION

For simplicity and illustrative purposes, the present disclosure is described by referring mainly to examples thereof. In the following description, details are set forth in order to provide an understanding of the present disclosure. It will be readily apparent however, that the present disclosure may be practiced without limitation to these details. In other instances, some methods and structures have not been described in detail so as not to unnecessarily obscure the present disclosure.

Throughout the present disclosure, the terms “a” and “an” are intended to be at least one of a particular element. As used herein, the term “includes” means includes but not limited to, the term “including” means including but not limited to. The term “based on” means based at least in part on.

Radio frequency (RF) interference that impacts cellular communications, e.g., 4G Long Term Evolution (LTE) and/or 5G New Radio (NR) networks, is commonly generated by other radios, external devices, and passive intermodulation (PIM). PIM interference generally occurs when RF energy from two or more frequencies is non-linearly mixed in a passive element, such as a bad RF connection, damaged cables, rusty metal, poor antennas, metallic structures, etc. For instance, external PIM interference can occur in cell sites when a non-linear passive component is located in the vicinity of the transmit antennas of the radios. PIM interference may be harmful when it is present in the uplink receive channels of the radios since the undesired PIM interference is mixed with the received signal resulting in a deteriorated signal that is unusable, causing re-transmissions or completely lost communication.

In a conventional approach, external PIM detection is done with a PIM test probe connected to a spectrum analysis device. Particularly, a user of the PIM test probe moves the PIM test probe into close proximities of, and in some instances, in contact with, potential PIM interference sources and the PIM test probe detects levels, e.g., power levels, of RF interference from the potential PIM interference sources. The detected levels of RF interference are displayed on the spectrum analysis device and the user may determine whether the potential PIM interference sources are creating significant RF interference levels. In many instances, the cell sites are positioned on the rooftops of buildings, which typically include large numbers of various equipment, cables, and other objects that may represent potential trip or other hazards for the user, in addition to potential falls from the rooftops. As a result, it is often dangerous for the user to walk around the rooftops to position the PIM test probe in close proximities to the potential interference sources.

Disclosed herein are apparatuses and systems for localizing and visualizing RF interference, and particularly, for localizing and visualizing locations of PIM interference. The apparatuses disclosed herein include an RF antenna that can include an RF enclosure with reflective or absorbent material. The apparatuses also include a camera positioned in line with the RF antenna to capture images of objects in the field of view of the camera. The apparatuses disclosed herein are thus able to detect the power levels of RF interference sources and to capture images of those RF interference sources. The apparatuses are also able to capture additional information corresponding to the capture of the images and the detection of the RF signals including, for instance, geo-location (latitude and longitude), azimuth, elevation, and polarization.

Through implementation of the features of the present disclosure, a user, such as a technician, may identify sources of RF interference, and particularly, PIM interference, in a safe and efficient manner. That is, through use of the apparatus and the test device discussed herein, the user may test for PIM interference across multiple potential PIM interference sources while remaining stationary or relatively stationary. As a result, the user is less likely to face the potential hazards that are typically present near cell sites and the user may identify potential PIM interference sources relatively quickly.

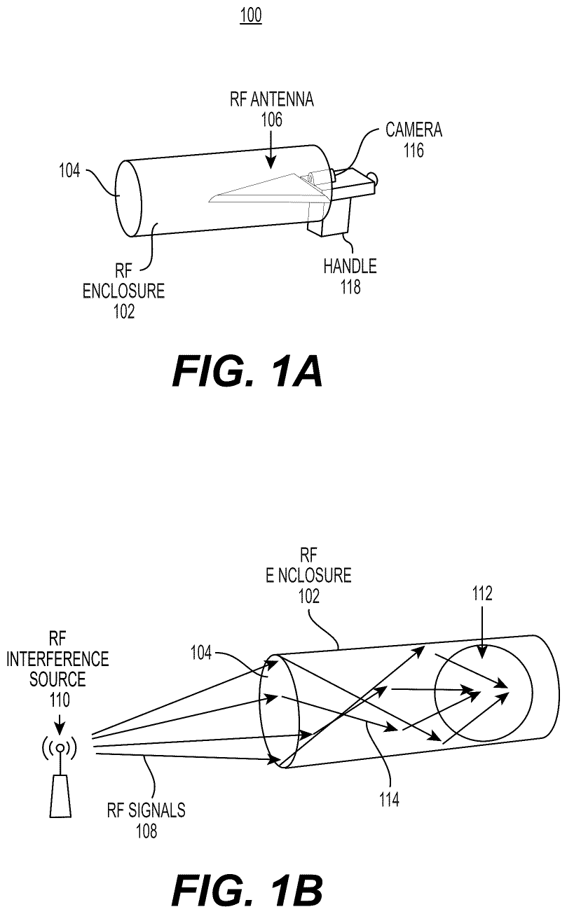

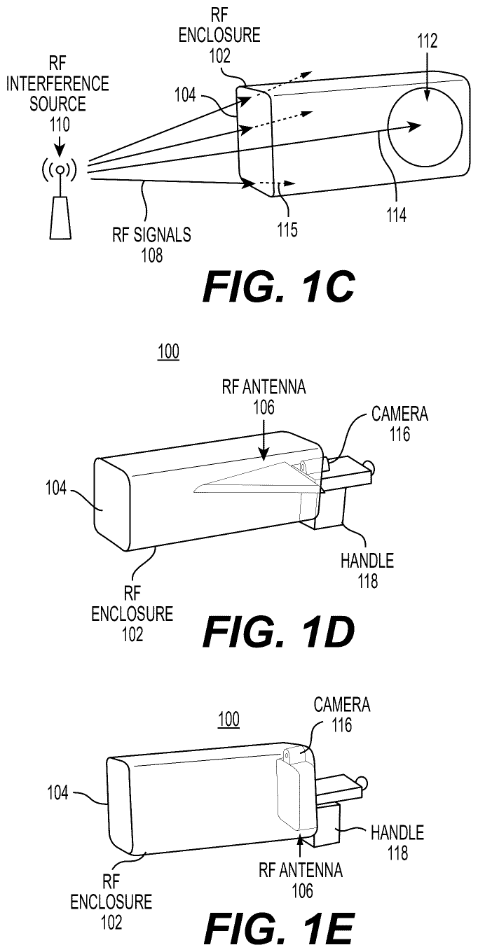

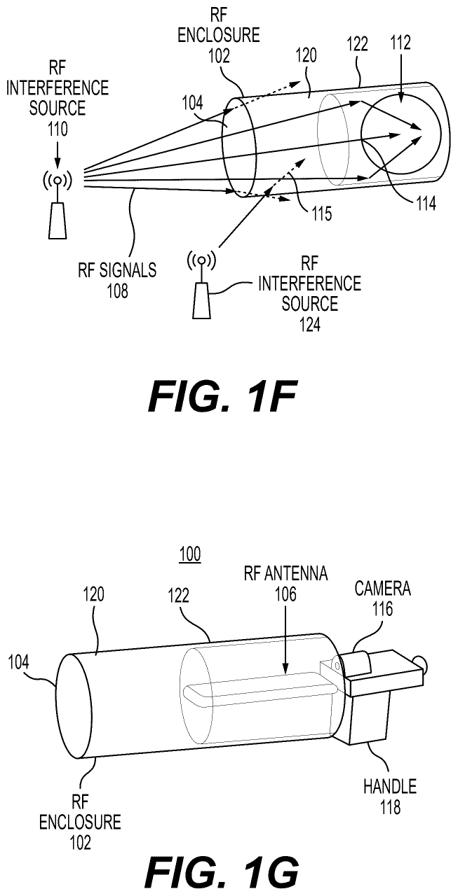

FIG. 1A shows a side perspective view of an apparatus 100 for localizing and visualizing RF interference, and particularly, PIM interference, according to an example of the present disclosure. FIG. 1B shows a side perspective view of an RF enclosure with an RF reflective material to cause constructive interference of RF signals 108 of the apparatus 100 depicted in FIG. 1A, according to an example of the present disclosure. FIG. 1C shows a side perspective view of an RF enclosure 102 with an RF absorbent material to cause attenuation of non-directional RF signals 108 of an apparatus 100 for localizing and visualizing RF interference, according to an example of the present disclosure. FIGS. 1D and 1E, respectively, show side perspective views of apparatuses 100 for localizing and visualizing RF interference, according to examples of the present disclosure.

FIG. 1F shows a side perspective view of an RF enclosure 102 with a combination of an RF absorbent material 120 to cause attenuation of non-directional RF signals 108 and an RF reflective material 122 to cause constructive interference of RF signals 108 of the apparatus 100 for localizing and visualizing RF interference, according to an example of the present disclosure. FIG. 1G shows a side perspective view of an apparatus 100 having the RF enclosure 102 shown in FIG. 1F, according to an example of the present disclosure. It should be understood that the apparatuses 100 and the RF enclosures 102 shown in FIGS. 1A-1G may have different geometries and/or include additional features and that some of the features described herein may be removed and/or modified without departing from a scope of the present disclosure.

As shown in FIG. 1A, the RF enclosure 102 of the apparatus 100 includes an opening 104 and is generally hollow. The RF enclosure 102 is shown as being partially transparent for illustration purposes such that an interior of the RF enclosure 102 is visible. In general, the RF enclosure 102 may be formed of a substantially rigid and opaque material. For instance, the RF enclosure 102 may be formed of a rigid plastic material, a metallic material, a composite material, and/or the like.

As also shown in FIG. 1A, the apparatus 100 may include an RF antenna 106 housed within the RF enclosure 102. The RF antenna 106 may be any suitable type of RF antenna, for instance, a type of directional antenna that may detect RF signals emanating from a direction in which the RF antenna 106 is positioned. Particularly, in some examples, the RF antenna 106 may receive greater radio wave power in the specific direction in which the RF antenna 106 is facing. In other words, the RF antenna 106 may focus the direction in which RF energy is received. By way of particular example, the RF antenna 106 may be a broadband log periodic antenna available from Viavi Solutions, Inc. of Germantown, MD. In other examples, the RF antenna 106 may not be a directional antenna, but may be, for instance, a cross-polarized RF antenna, an omni-directional RF antenna, or the like.

In addition, the RF enclosure 102 may include or be formed of an RF reflective material, an RF absorbent material, or a combination thereof. In some examples, the interior wall of the RF enclosure 102 may include or be formed of an RF reflective material, an RF absorbent material, or a combination thereof. In some examples, the interior wall of the RF enclosure 102 may include or be formed of an RF reflective material and an exterior wall of the RF enclosure may include or be formed of an RF absorbent material. In some examples, the entirety of the RF enclosure 102 may be formed of an RF reflective material, an RF absorbent material, or a combination of RF reflective and RF absorbent materials. In some examples, a first portion of the RF enclosure 102 near the opening 104 may be formed of an RF absorbent material and a second portion of the RF enclosure 102 away from the opening 104 may be formed of an RF reflective material. By way of example, the RF absorbent material may include a metallic material, such as aluminum, copper, gold, silver, and/or the like. In examples in which the RF reflective material is applied to the interior wall of the RF enclosure 102, the RF reflective material may include a metallic coating, such as a copper, silver, gold, and/or the like, coating. In examples in which the RF enclosure 102 includes an RF absorbent material, the RF enclosure 102 may include, for instance, polymer resin loaded with flexible and soft metal flake filler, or the like.

In any of these examples, and as shown in FIGS. 1B, 1C, and, 1F, the RF enclosure 102 may cause RF signals 108 entering into the opening 104 from an RF interference source 110, e.g., a PIM interference source, to be directed toward a focal location 112 as denoted by arrows 114. In the example shown in FIG. 1B, the RF enclosure 102 includes an RF reflective material and thus, the arrows 114 denote that the RF signals 108 reflect off the internal surface of the RF enclosure 102 and may be focused at the focal location 112 through constructive interference. According to examples, the RF antenna 106 may be positioned to detect the RF signals at the focal location 112.

In the example shown in FIG. 1C, the RF enclosure 102 may include an RF absorbent material and thus, the arrow 114 may represent RF signals 108 that are directed to the focal location 112. In addition, the arrows 115 represent non-directional RF signals 108, e.g., RF signals that do not travel directly through the RF enclosure 102 to the focal location 112. The RF absorbent material in the RF enclosure 102 shown in FIG. 1C may absorb the non-directional RF signals represented by the arrows 115. In other words, the arrows 115 denote that the RF absorbent material in the RF enclosure 102 attenuates the RF signals 108 that are not directional to the focal location 112 through the opening 104 of the RF enclosure 102.

FIG. 1D shows that the example apparatus 100 for localizing and visualizing RF interference may include the RF antenna 106 shown in FIG. 1A and an RF enclosure 102 that includes an RF absorbent material. FIG. 1E shows that the example apparatus 100 for localizing and visualizing RF interference may include an RF enclosure 102 that includes an RF absorbent material and an RF antenna 106 that is non-directional. For instance, the RF antenna 106 shown in FIG. 1E may be a cross-polarized antenna.

In the example shown in FIG. 1F, the RF enclosure 102 may include a combination of an RF absorbent material 120 and an RF reflective material 122. Particularly, a first portion of the RF enclosure 102 near the opening 104 may include the RF absorbent material 120 and a second portion of the RF enclosure 102 in which the focal location 112 is positioned may include the RF reflective material 122. As a result, the RF signals 108 that enter through the opening 104 at a sufficient angle that is offset from the center of the opening 104 may be absorbed by the RF absorbent material 120. This may include RF signals 108 emitted by an RF interference source 124 that is directed to an exterior of the RF enclosure 102. However, RF signals 108 that enter through the opening 104 and reach the second portion of the RF enclosure 102 may be directed to the focal location 112 either directly or after reflecting off the RF reflective material 122.

According to examples in which the RF antenna 106 may be a directional antenna, the RF antenna 106 may have a directivity of around ±35° or greater. In examples in which the RF antenna 106 is not a directional antenna, such as a cross-polarized RF antenna, an omni-directional RF antenna, or the like, the RF antenna 106 may have a directivity that is greater than 35°. However, due to the more focused directivity created by the RF enclosure 102, the directivity of the RF antenna 106 inside of the RF enclosure 102 may be reduced to around ±15° from a center line of the RF enclosure 102. As a result, by positioning the RF antenna 106 within the RF enclosure 102 as discussed herein, the RF antenna 106 may have a more focalized directivity, which may enable a more accurate determination of a location of the RF interference source 110.

With reference to FIGS. 1A, 1D, 1E, and 1G, the apparatus 100 may also include a camera 116 to capture images of objects in a field of view of the camera 116. The camera 116 may be a digital still camera or a digital video camera. As shown, the camera 116 may be positioned in line with the RF antenna 106 such that the camera 116 and the RF antenna 106 face the same direction. In this regard, the camera 116 is positioned to capture images of objects to which the RF antenna 106 is facing. In some examples, the camera 116 has a fixed zoom level while in other examples, the camera 116 is able to zoom at variable levels. In some instances, the camera 116 is an autofocus camera.

As shown in FIGS. 1A, 1D, 1E, and 1G, the camera 116 may be positioned within the RF enclosure 102 and thus, the field of view of the camera 116 may be limited to what is visible through the opening 104. In other examples, the camera 116 may be positioned outside of the RF enclosure 102, for instance, on top of, below, or on the side of the RF enclosure 102. In addition, although the RF enclosure 102 has been depicted as having a cylindrical or rectangular cross-sectional shape, it should be understood that the RF enclosure 102 may have other cross-sectional shapes, e.g., a polygonal shape, without departing from a scope of the present disclosure.

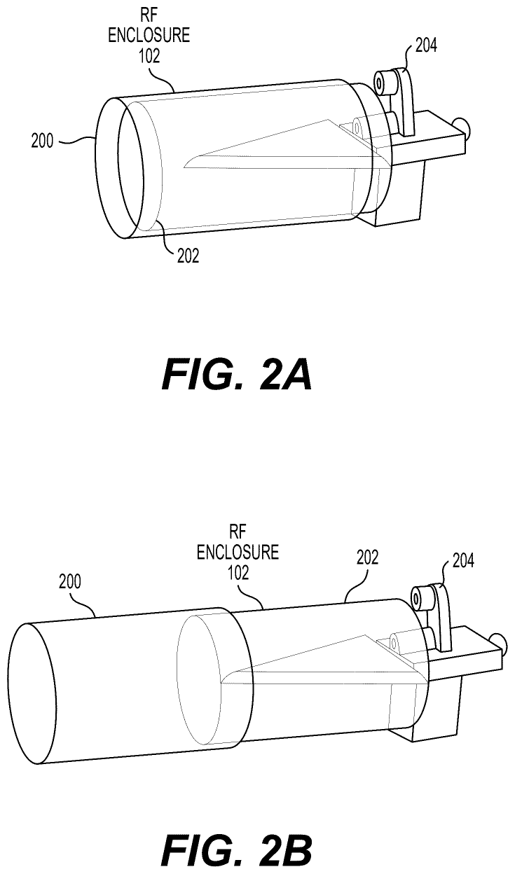

FIGS. 2A and 2B, respectively, show side perspective views of the apparatus 100 shown in FIG. 1A, in which the RF enclosure 102 of the apparatus 100 has a variable length, according to an example of the present disclosure. Although not shown, it should be understood that the features shown in FIGS. 2A and 2B may also be applicable to the apparatuses 100 shown in FIGS. 1D, 1E, and 1G. Accordingly, the descriptions of FIGS. 2A and 2B may equally be applicable to the apparatuses 100 shown in FIGS. 1D, 1E, and 1G. In other words, the RF enclosure 102 includes RF reflective and/or RF absorbent materials and may have a variable length as discussed herein with respect to the RF enclosure 102.

As shown in FIGS. 2A and 2B, the RF enclosure 102 may be composed of multiple sections 200, 202, in which a first section 200 may be movable with respect to a second section 202. Particularly, the first section 200 and the second section 202 may be in sliding or telescoping relationship with each other such that the total length of the RF enclosure 102 may be varied. The sliding relationship between the first section 200 and the second section 202 may be effectuated in any of a variety of manners. For instance, the first section 200 may have a slightly larger diameter than the second section 202 such that the first section 200 may move over the second section 202. In other examples, the first section 200 may have a slightly smaller diameter than the second section 202. In any of these examples, a sliding mechanism, such as rails, may be provided between the first section 200 and the second section 202 to enable smooth movement between the first section 200 and the second section 202.

Although the RF enclosure 102 has been depicted as having two sections 200, 202, it should be understood that in other examples, the RF enclosure 102 may have more than two sections without departing from a scope of the present disclosure.

According to examples, and as shown in FIGS. 2A and 2B, the apparatus 100 may include a sensor 204 to detect a length of the RF enclosure 102. In the examples shown in FIGS. 2A and 2B, the sensor 204 may be a sensor that may detect the length of the RF enclosure 102 through a visual or other light-based detection technique. In other examples, the sensor 204 may physically detect the position of the first section 202 with respect to the second section 202. For instance, the sensor 204 may be an encoder or other type of sensor.

In some examples in which the camera 116 has a zooming function, the zoom level of the camera 116 may be varied depending upon the length of the RF enclosure 102 detected by the sensor 204. For instance, the camera 116 may have a higher zoom level when the RF enclosure 102 is in an extended position as shown in FIG. 2B. Likewise, the camera 116 may have a lower zoom level when the RF enclosure 102 is in a collapsed position as shown in FIG. 2A. In other examples, the camera 116 may have a lower zoom level when the RF enclosure 102 is in the extended position and may have a higher zoom level when the RF enclosure 102 in the collapsed position.

The apparatus 100 may also include a handle 118 on which the RF directional antenna 106, the RF enclosure 102, and the camera 116 may be mounted. A user of the apparatus 100 may maneuver the apparatus 100 into various positions through use of the handle 118. As discussed herein, the handle may also house additional components of the apparatus 100, such as a low noise amplifier, a global positioning system (GPS) device, an electronic compass, and/or the like.

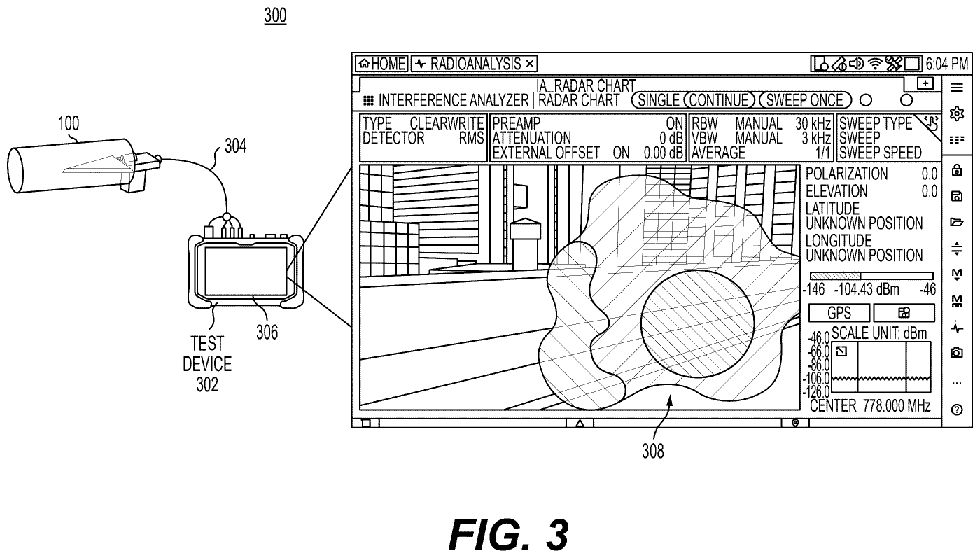

FIG. 3 shows a diagram of a system 300 for localizing and visualizing RF interference, e.g., PIM interference, which includes the apparatus 100 shown in FIG. 1A, according to an example of the present disclosure. Although not shown, it should be understood that the features shown in FIG. 3 may also be applicable to the apparatuses 100 shown in FIGS. 1D, 1E, and 1G. Accordingly, the description of FIG. 3 may equally be applicable to the apparatuses 100 shown in FIGS. 1D, 1E, and 1F. For instance, the apparatus 100 shown in FIG. 3 may be replaced with an apparatus 100 that includes one of the apparatuses 100 shown in FIGS. 1D, 1E, and 1G.

As shown, the system 300 may also include a test device 302 to which the apparatus 100 may be in communication through one or more cables 304. Particularly, the apparatus 100 may communicate detected RF signal levels and captured images, e.g., videos, to the test device 302 through the one or more cables 304. In other examples, the apparatus 100 may communicate wirelessly with the test device 302, for instance, through a Bluetooth™ connection, a WiFi connection, or the like.

According to examples, the test device 302 is to display the images received from the camera 116 of the apparatus 100 on a display 306 of the test device 302. An enlarged view of the display 306 is shown in FIG. 3 for purposes of illustration. The test device 302 is also to display a heat map 308 of the detected RF signals received from the RF directional antenna 106 of the apparatus 100. Particularly, the test device 302 may convert the power levels of the RF signals received from the apparatus 100 into the heat map 308. The test device 302 may overlay the heat map 308 with the locations on the displayed image according to the locations at which the RF signals were detected.

The heat map 308 may represent the various RF signal power levels with different colors. For instance, the test device 302 may represent lower RF signal power levels with lighter colors and may represent higher RF signal power levels with darker colors. In addition or alternatively, the test device 302 may represent the RF signal power levels with a range of colors. By way of particular example, the test device 302 may represent lower RF signal power levels with a yellow color, middle RF signal power levels with an orange color, and higher RF signal power levels with a red color.

The test device 302 may also show the additional characteristics of the apparatus 100, e.g., the geo-location (latitude and longitude), the azimuth, the elevation, and the polarization of the apparatus 100 during capture of the RF signals as shown in FIG. 3. In addition, the test device 302 may show the detected RF signal power levels in graphical form as shown in FIG. 3. The test device 302 may be any suitable type of device that is able to analyze RF signal power levels and to display the power levels. By way of particular example, the test device 302 is the OneAdvisor 800™ available from Viavi Solutions, Inc. of Germantown, MD. Through use of the system 300, a user may determine and visualize

the locations at which RF signal interference, e.g., PIM interference, is occurring. The user may make this determination without having to walk around a cell site to each location of a potential PIM interference source. Instead, the user may direct the apparatus 100 toward the potential PIM interference sources and may capture images of the potential PIM interference sources and the RF signal power levels of the potential PIM interference sources from a distance. As a result, the user may not be required to walk around potentially dangerous locations to determine the locations of potential PIM interference sources, which may enable the user to determine the locations of potential PIM interference sources in a safe and efficient manner.

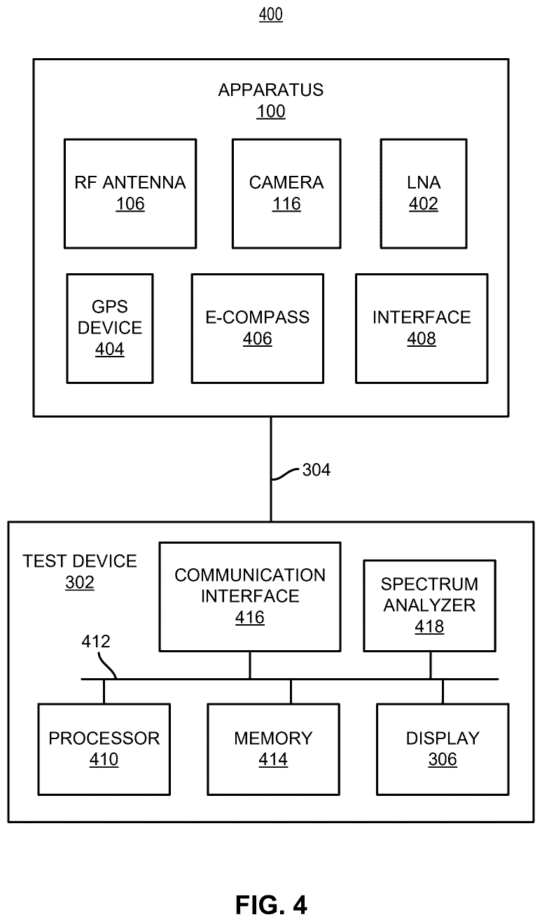

FIG. 4 shows a block diagram 400 of the system 300 depicted in FIG. 3, according to an example of the present disclosure. As shown, the system 300 includes the apparatus 100 and the test device 302 shown in FIG. 3. The apparatus 100 may include the RF antenna 106 and the camera 116 discussed herein with respect to FIG. 1A. The apparatus 100 may also include a low noise amplifier (LNA) 402, which boosts signals sent to the test device 302 without significantly adding noise to the signal and thus improves signal-to-noise ratio of the signal. The apparatus 100 may further include a GPS device 404 and an electronic compass (E-compass) 406. The GPS device 404 may calculate the geo-location of the apparatus 100 and the electronic compass 406 may determine the azimuth, the elevation, and the polarization of the apparatus 100. The apparatus 100 may communicate the detected information to the test device 302 through an interface 408 and the one or more cables 304.

Although not shown in FIG. 4, the apparatus 100 may include a sensor that detects a length of the RF enclosure 102. The sensor may be equivalent to the sensor 204 depicted in FIGS. 2A and 2B. As discussed herein, the sensor may detect the length of the RF enclosure 102 in any of a number of manners. In addition, the detected length of the RF enclosure 102 may be employed to change the zoom level of the camera 116, for instance, to enhance or optimize the capture of images through the opening of the RF enclosure 102.

The test device 302 may include a processor 410, a bus 412, a memory 414, a spectrum analyzer 418, and a display 306. In some examples, the memory 414 may store instructions, e.g., machine-readable instructions, for the processor 410 to localize and display images captured by the camera 116 and to display a heat map 308 of the detected RF signal power levels as discussed herein. For instance, the processor 410 may cause images of objects captured by the camera 116 to be displayed on the display 306 and to overlay the heat map 308 of the detected RF signal power levels on the displayed images of the objects.

The bus 412 may be a component that permits communication among the components of the test device 302. The processor 410 may be implemented in hardware, firmware, or a combination of hardware and software and may include one or more of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, the processor 410 includes one or more processors capable of being programmed to perform a function. The memory 414 may include one or more memories such as a random access memory (RAM), a read only memory (ROM), and/or another type of dynamic or static storage device (e.g., a flash memory, a magnetic memory, and/or an optical memory) that stores information and/or instructions for use by the processor 410.

The communication interface 416 includes a transceiver-like component (e.g., a transceiver and/or a separate receiver and transmitter) that enables the test device 302 to communicate with other devices, such as via a wired connection, a wireless connection, or a combination of wired and wireless connections. The communication interface 416 may permit the test device 302 to receive information from another device, e.g., the apparatus 100, and/or provide information to another device. For example, the communication interface 416 may include an Ethernet interface, an optical interface, a coaxial interface, an infrared interface, an RF interface, a universal serial bus (USB) interface, a Wi-Fi interface, a cellular network interface, or the like.

The test device 302 may include components other than or in addition to those shown in FIG. 4. For example, the test device 302 may include a storage component that stores information and/or software related to the operation and use of test device 302. The storage component may be a hard disk (e.g., a magnetic disk, solid state disk, etc.) and/or another type of non-transitory computer-readable medium. The test device 302 may also include an input component that may include a component that permits the test device 302 to receive information, such as via user input (e.g., a touch screen display, a keyboard, a keypad, a mouse, a button, a switch, and/or a microphone). The test device 302 may further include an output component that may include a component that provides output information from the test device 302 (e.g., a display 306, a speaker, a user interface, and/or one or more light-emitting diodes (LEDs)).

The test device 302 may still further include a battery module that may be connected along the bus 412 to supply power to the processor 410, the memory 414, and other components of the test device 302. The battery module permits the test device 302 to be a portable integrated device for conducting field detection of RF interference.

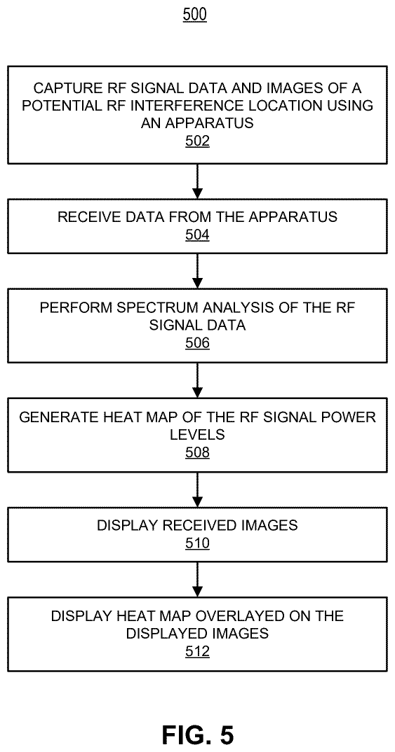

FIG. 5 shows a flow diagram of a method 500 for localizing and visualizing RF interference, e.g., PIM interference, according to an example of the present disclosure. It should be understood that the method 500 may include additional operations and that some of the operations described therein may be removed and/or modified without departing from the scope of the method 500. The description of the method 500 is made with reference to the features depicted in FIGS. 1A-4 for purposes of illustration.

At block 502, the apparatus 100 may be used to detect RF signal data and capture images of a potential RF interference location. As discussed herein, a user may point the apparatus 100 toward the potential RF interference location such that the RF antenna 106 is directed toward the potential RF interference location. In addition, the camera 116 may concurrently capture one or more images of the potential RF interference location. The apparatus 100 may communicate data corresponding to the RF signal power levels detected by the RF antenna 106 and the images captured by the camera 116 to the test device 302, for instance, through the one or more cables 304.

The GPS device 404 of the apparatus 100 may determine the geo-location of the apparatus 100. The electronic compass of the apparatus 100 may also determine the azimuth, the elevation, and the polarization of the apparatus 100. In addition, the apparatus 100 may communicate this data to the test device 302.

At block 504, the test device 302 may receive the data communicated from the apparatus 100. The test device 302 may receive the data through the communication interface 416.

At block 506, the test device 302 may perform spectrum analysis of the RF signal data. In other words, the spectrum analyzer 418 of the test device 302 may determine a graphical representation of the RF signal power levels identified in the data received from the apparatus 100. In some examples, the spectrum analyzer 418 may determine the power or amplitudes of multiple frequency components and may graphically represent the amplitudes.

At block 508, the processor 410 or the spectrum analyzer 418 may generate a heat map 308 of the detected RF signal power levels. As discussed herein, the heat map 308 may visually represent the detected RF signal power levels such that the higher RF signal power levels may be distinguished from the lower RF signal power levels.

At block 510, the processor 410 may display the received images of the potential RF interference location on the display 306. In addition, at block 512, the processor 410 may display the heat map 308 as an overlay on the images displayed on the display 306, for instance, as shown in FIG. 3. By overlaying the heat map 308 on the images, the locations at which the greatest levels of RF signal interference are occurring may be visualized. In addition, a user may determine from the displayed images and the heat map 308 whether the potential RF interference location is generating a significant level of RF interference. For instance, the user may determine that RF interference is present at the potential RF interference location when the heat map 308 shows a certain color at that location on the image. Likewise, the user may determine that RF interference is not present at the potential RF interference location when the heat map 308 does not show the certain color at that location on the image.

According to examples in which the RF enclosure 102 includes multiple telescoping sections 200, 202, a user may move the first section 200 with respect to the second section 202 to thus vary the length of the RF enclosure 102. The user may vary the length of the RF enclosure 102 to vary the sensitivity of the RF antenna 106. For instance, the user may increase the length of the RF enclosure 102 to increase the directivity of the RF antenna 106 and may decrease the length of the RF enclosure 102 to decrease the directivity of the RF antenna 106. In addition, the user may increase the length of the RF enclosure 102 to decrease the field of view of the camera 116 and may decrease the length of the RF enclosure 102 to increase the field of view of the camera 116. In these examples, the sensor 204 may detect the length of the RF enclosure 102 and may adjust the zoom level of the camera 116 based on the detected length.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus for localizing and visualizing radio frequency (RF) interference comprising:
an RF enclosure having an opening;
an RF antenna housed within the RF enclosure, wherein the RF antenna is to detect RF signals emanating from a direction in which the RF antenna is positioned, and wherein the RF enclosure is to cause RF signals entering the opening to be directed to the RF antenna;
a camera positioned in line with the RF antenna to capture images of objects in a field of view of the camera; and
wherein the RF antenna is to output detected RF signals to a test device and the camera is to output the captured images to the test device, and wherein the test device is to display the captured images and to display a heat map of the detected RF signals over the captured images.

2. The apparatus of claim 1, wherein the RF enclosure comprises an interior wall and wherein the interior wall includes an RF reflective material, an RF absorbent material, or a combination thereof, and wherein the RF enclosure is to cause at least one of constructive interference or attenuation of non-directional signals at the RF antenna.

3. The apparatus of claim 1, wherein the RF enclosure has a fixed length.

4. The apparatus of claim 1, wherein the RF enclosure has a variable length.

5. The apparatus of claim 1, wherein the camera is positioned within the RF enclosure.

6. The apparatus of claim 1, wherein the camera is positioned outside of the RF enclosure.

7. The apparatus of claim 1, wherein the camera has a fixed zoom level.

8. The apparatus of claim 1, wherein the camera has a variable zoom functionality.

9. The apparatus of claim 8, wherein the RF enclosure has a variable length, the apparatus further comprising:
a sensor to detect a length of the RF enclosure, wherein a zoom level of the camera is to be varied based on the detected length of the RF enclosure.

10. The apparatus of claim 1, further comprising:
a handle; and
a base attached to the handle, the handle housing:
a low noise amplifier;
a global positioning system unit; and
an electronic compass.

11. A system for localizing and visualizing radio frequency (RF) interference comprising:
a test device having a display;
an apparatus comprising:
an RF enclosure having an opening and an interior wall having at least one of an RF reflective, an RF absorbent material, or a combination thereof;
an RF antenna housed within the RF enclosure;
a camera positioned to capture images of objects within a direction in which the RF antenna is facing; and
wherein the RF antenna is to output detected RF signals to the test device and the camera is to output captured images to the test device, and wherein the test device is to display the captured images and to display a heat map of the detected RF signals over the captured images depending upon locations at which the RF signals were detected.

12. The system of claim 11, wherein a length of the RF enclosure is variable to multiple lengths.

13. The system of claim 12, further comprising:
a sensor to detect a length of the RF enclosure, wherein a zoom level of the camera is to be varied based on the detected length of the RF enclosure.

14. The system of claim 11, wherein the camera is positioned within the RF enclosure.

15. The system of claim 11, wherein the apparatus further comprises:
a handle; and
a base attached to the handle, the handle housing:
a low noise amplifier;
a global positioning system unit; and
an electronic compass.

16. The system of claim 15, wherein the apparatus is to use the low noise amplifier to boost signals sent to the test device, and to output a geographic location information and information detected by the electronic compass to the test device.

17. The system of claim 16, wherein the test device is to display the geographic location information and the information detected by the electronic compass on a display of the test device.

18. A method for localizing and visualizing passive intermodulation interference comprising:
receiving, by a processor, data from an apparatus having a RF antenna housed within an RF enclosure and a camera, wherein the data comprises RF signal data detected by the RF antenna and images captured by the camera;
performing, by the processor, spectrum analysis of the RF signal data to determine RF signal power levels;
generating, by the processor, a heat map of the RF signal power levels;
displaying, by the processor, images captured by the camera; and
displaying, by the processor, the heat map overlayed on the displayed images.

19. The method of claim 18, further comprising:
receiving geographic location information of the apparatus; and
displaying the received geographic location information on a display of a test device.

20. The method of claim 18, further comprising:
receiving information detected by an electronic compass of the apparatus; and
displaying the received information detected by the electronic compass on a display of a test device.
